(19) United States
(12) Patent Application Publication
(10) Pub. No.: US 2020/0413435 A1
(43) Pub. Date: Dec. 31, 2020

(54) METHOD OF REPORTING CONFIGURED GRANT CONFIRMATION AND RELATED DEVICE

(71) Applicant: FG Innovation Company Limited, Tuen Mun (HK)

(72) Inventors: HENG-LI CHIN, Taipei (TW); CHIA-HUNG WEI, Taipei (TW); WAN-CHEN LIN, Taipei (TW); HSIN-HSI TSAI, Taipei (TW); CHIE-MING CHOU, Taipei (TW)

(21) Appl. No.: 16/913,618

(22) Filed: Jun. 26, 2020

Related U.S. Application Data
(60) Provisional application No. 62/868,802, filed on Jun. 28, 2019.

(51) Int. Cl. H04W 72/14; H04W 76/27; H04L 5/00; H04W 80/02; H04W 72/04; H04W 76/11

(52) U.S. Cl. CPC H04W 72/14; H04W 76/27; H04L 5/0092; H04W 76/11; H04W 80/02; H04W 72/042; H04L 5/0098

(57) ABSTRACT

A method of reporting a configured grant (CG) confirmation for a user equipment (UE) of a wireless communication system is disclosed. The method comprises receiving a radio resource control (RRC) message for configuring the UE with at least one CG configuration in a bandwidth part (BWP) of a cell, from a network of the wireless communication system, receiving a (de)activation command for activating or deactivating the at least one configured CG configuration, from the network, generating a medium access control (MAC) control element (CE) for reporting the CG confirmation indicating whether the at least one configured CG configuration is activated or deactivated by the (de)activation command, according to a first indication of the RRC message, wherein the first indication is associated with the configured at least one CG configuration, and transmitting the MAC CE, to the network.

### CROSS-REFERENCE TO RELATED APPLICATION(S)

The present disclosure claims the benefit of and priority to U.S. provisional Patent Application Ser. No. 62/868,802 filed on Jun. 28, 2019, entitled “Configured uplink grant confirmation mechanism in the presence of multiple active configured uplink grant configurations,” (hereinafter referred to as “the '802 provisional”). The disclosure of the '802 provisional is hereby incorporated fully by reference into the present disclosure.

### FIELD

The present disclosure generally relates to wireless communications, and more particularly, to a method of reporting a configured grant confirmation and a related device.

### BACKGROUND

In the new radio (NR) Rel-15 technical standard, a configured grant (CG) confirmation is triggered after a reception of an uplink (UL) grant, set up for configured grant Type 2 activation/deactivation, on a physical downlink (DL) control channel (PDCCH) scrambled with a Configured Scheduling (CS) Radio Network Temporary Identifier (RNTI). If the CG confirmation has not been canceled at the time when the medium access control (MAC) entity has uplink resources allocated for a new transmission, the MAC entity may instruct the Multiplexing and Assembly procedure to generate a CG confirmation MAC control element (CE).

The CG confirmation MAC CE is reported by a user equipment (UE) to a base station (BS), and is identified by a MAC protocol data unit (PDU) subheader with a specific logical channel identity (LCID). For example, the CG confirmation MAC CE is in a fixed size of zero bits, and this CG confirmation MAC CE is indicated by the LCID of 55. Upon reception of the CG confirmation MAC CE from the UE, the BS knows that the UE has received the configured grant Type 2 activation/deactivation to activate/deactivate a configured grant Type 2 configuration for a given bandwidth part (BWP) of a serving cell. It is noted that in the NR Rel-15 technical standard, at most one configured grant Type 2 configuration could be configured and activated for a given BWP of a serving cell. Hence, the UE may not need to indicate additional information associated with the configured grant Type 2 configuration in the CG confirmation MAC CE.

On the other hand, in the NR Rel-16 technical standard, one or more configured grant Type 2 configurations could be configured for a given BWP of a serving cell. As a result, the zero-bit CG confirmation MAC CE in the NR Rel-15 technical standard is not able to assist the BS to identify which of the configured grant Type 2 configurations has been activated/deactivated by the UE for the given BWP of the serving cell. Hence, a new CG confirmation reporting mechanism is needed in NR Rel-16 technical standard.

### SUMMARY

The present disclosure is directed to a method of reporting a configured grant (CG) confirmation and a related device.

According to an aspect of the present disclosure, a method of reporting a configured grant (CG) confirmation for a user equipment (UE) of a wireless communication system is disclosed. The method comprises receiving, from a network of the wireless communication system, a radio resource control (RRC) message for configuring the UE with at least one CG configuration in a bandwidth part (BWP) of a cell, receiving, from the network, a (de)activation command for activating or deactivating the configured at least one CG configuration, generating a medium access control (MAC) control element (CE) for reporting the CG confirmation indicating whether the configured at least one CG configuration is activated or deactivated by the (de)activation command, according to a first indication of the RRC message, the first indication being associated with the configured at least one CG configuration, and transmitting the MAC CE to the network.

According to another aspect of the present disclosure, a user equipment (UE) for reporting a configured grant (CG) confirmation is disclosed. The UE comprises a processor, for executing computer-executable instructions, and a non-transitory machine-readable medium, coupled to the processor, for storing the computer-executable instructions, wherein the computer-executable instructions instruct the processor to receive, from a network of the wireless communication system, a radio resource control (RRC) message for configuring the UE with at least one CG configuration in a bandwidth part (BWP) of a cell, receive, from the network, a (de)activation command for activating or deactivating the configured at least one CG configuration, generate a medium access control (MAC) control element (CE) for reporting the CG confirmation indicating whether the configured at least one CG configuration is activated or deactivated by the (de)activation command, according to a first indication of the RRC message, the first indication being associated with the configured at least one CG configuration, and transmit the MAC CE to the network.

### BRIEF DESCRIPTION OF THE DRAWINGS

Aspects of the exemplary disclosure are best understood from the following detailed description when read with the accompanying figures. Various features are not drawn to scale, dimensions of various features may be arbitrarily increased or reduced for clarity of discussion.

FIG. 1 is a flowchart illustrating a configured grant confirmation, in accordance with example implementations of the present disclosure.

FIG. 2, FIG. 3, FIG. 4, FIG. 5 and FIG. 6 are schematic diagrams illustrating a CG confirmation MAC CE, in accordance with example implementations of the present disclosure.

FIG. 7 is a block diagram illustrating a node for wireless communication, in accordance with example implementations of the present disclosure.

### DESCRIPTION

The following description contains specific information pertaining to exemplary implementations in the present disclosure. The drawings and their accompanying detailed description are directed to exemplary implementations. However, the present disclosure is not limited to these exemplary implementations. Other variations and implementations of the present disclosure will occur to those skilled in the art. Unless noted otherwise, like or corresponding elements in the figures may be indicated by like or corresponding reference numerals. Moreover, the drawings and illustrations are generally not to scale and are not intended to correspond to actual relative dimensions.

For consistency and ease of understanding, like features are identified (although, in some examples, not shown) by numerals in the exemplary figures. However, the features in different implementations may be different in other respects, and therefore shall not be narrowly confined to what is shown in the figures.

The phrases “in one implementation,” and “in some implementations,” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the described combination, group, series, and equivalents.

Additionally, any two or more of the following paragraphs, (sub)-bullets, points, actions, behaviors, terms, alternatives, examples, or claims described in the following disclosure may be combined logically, reasonably, and properly to form a specific method. Any sentence, paragraph, (sub)-bullet, point, action, behaviors, terms, or claims described in the following disclosure may be implemented independently and separately to form a specific method. Dependency, e.g., “based on”, “more specifically”, “preferably”, “In one embodiment”, “In one implementation”, “In one alternative” etc., in the following disclosure refers to just one possible example that would not restrict the specific method.

For explanation and non-limitation, specific details, such as functional entities, techniques, protocols, and standards are set forth for providing an understanding of the described technology. In other examples, detailed description of well-known methods, technologies, system, and architectures are omitted so as not to obscure the description with unnecessary details.

Persons skilled in the art will recognize that any described network function(s) or algorithm(s) may be implemented by hardware, software, or a combination of software and hardware. Described functions may correspond to modules that are software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of applications specific integrated circuitry (ASIC), programmable logic arrays, and/or using one or more digital signal processor (DSPs). Although some of the disclosed implementations are directed to software installed and executing on computer hardware, alternative implementations as firmware or as hardware or combination of hardware and software are well within the scope of the present disclosure.

The computer readable medium includes but is not limited to random access memory (RAM), read only memory (ROM), erasable programmable read-only memory (EPROM), electrically erasable programmable read-only memory (EEPROM), flash memory, compact disc (CD) read-only memory (CD ROM), magnetic cassettes, magnetic tape, magnetic disk storage, or any other equivalent medium capable of storing computer-readable instructions.

A radio communication network architecture (e.g., a long term evolution (LTE) system, an LTE-Advanced (LTE-A) system, an LTE-A Pro system, or an New Radio (NR) system typically includes at least one base station (BS), at least one UE, and one or more optional network elements that provide connection with a network. The UE communicates with the network (e.g., a core network (CN), an evolved packet core (EPC) network, an Evolved Universal Terrestrial Radio Access Network (RAN) (E-UTRAN), a Next-Generation (GN) Core (NGC), 5G CN (5GC), or an internet via a RAN established by the BS.

It should be noted that, in the present disclosure, a UE may include, but is not limited to, a mobile station, a mobile terminal or device, a user communication radio terminal. For example, a UE may be a portable radio equipment, that includes, but is not limited to, a mobile phone, a tablet, a wearable device, a sensor, or a personal digital assistant (PDA) with wireless communication capability. The UE is configured to receive and transmit signals over an air interface to one or more cells in a RAN.

A BS may include, but is not limited to, a node B (NB) as in the UMTS, an evolved node B (eNB) as in the LTE-A, a radio network controller (RNC) as in the UMTS, a BS controller (BSC) as in the Global System for Mobile communications (GSM)/GSM Enhanced Data rates for GSM Evolution (EDGE) RAN (GERAN), an Next Generation (NG)-eNB as in an Evolved Universal Terrestrial Radio Access (E-UTRA) BS in connection with the 5GC, a next generation node B (gNB) as in the 5G-RAN, and any other apparatus capable of controlling radio communication and managing radio resources within a cell. The BS may connect to serve the one or more UEs via a radio interface to the network.

A BS may be configured to provide communication services according to at least one of the following radio access technologies (RATs): Worldwide Interoperability for Microwave Access (WiMAX), GSM (often referred to as 2G), GERAN, General Packet Radio Service (GRPS), UMTS (often referred to as 3G) according to basic wideband-code division multiple access (W-CDMA), high-speed packet access (HSPA), LTE, LTE-A, evolved LTE (eLTE), New Radio (NR, often referred to as 5G), and/or LTE-A Pro. However, the scope of the present disclosure should not be limited to these protocols.

The BS is operable to provide radio coverage to a specific geographical area using a plurality of cells forming the RAN. The BS supports the operations of the cells. Each cell is operable to provide services to at least one UE within radio coverage of the cell. More specifically, each cell (often referred to as a serving cell) provides services to serve one or more UEs within the cell's radio coverage, (e.g., each cell schedules the downlink (DL) and optionally UL resources to at least one UE within the cell's radio coverage for DL and optionally UL packet transmissions). The BS can communicate with one or more UEs in the radio communication system via the plurality of cells. A cell may allocate sidelink (SL) resources for supporting proximity service (ProSe), LTE SL service, and LTE/NR V2X services. Each cell may have overlapped coverage areas with other cells.

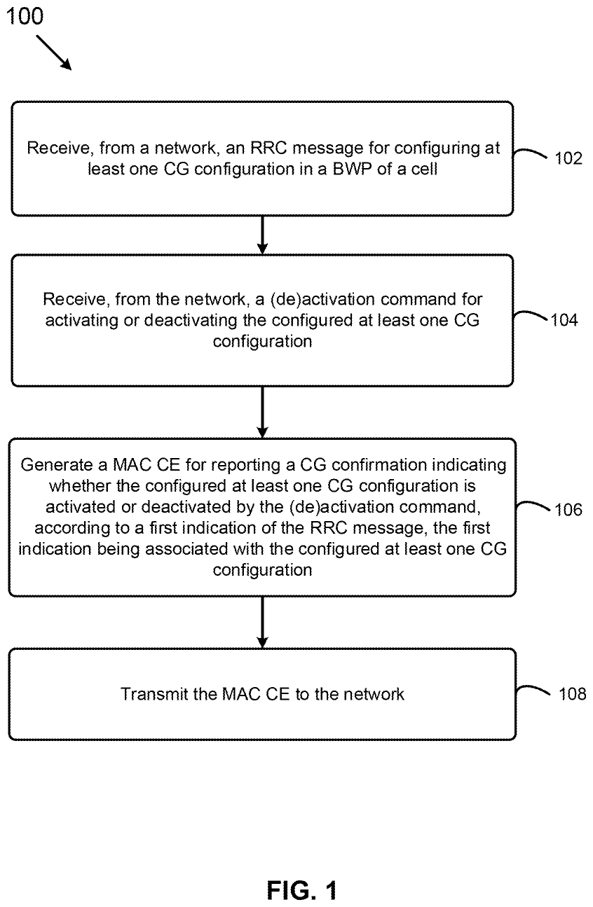

FIG. 1 illustrates a method 100 for a UE to report CG confirmation to a BS. In action 102, the UE receives a radio resource control (RRC) message for configuring the UE with at least one CG configuration in a bandwidth part (BWP) of a cell, from the BS. In action 104, the UE receives a (de)activation command for activating or deactivating (hereinafter “(de)activating”) the configured at least one CG configuration, from the BS. In action 106, the UE generates a MAC CE for reporting a CG confirmation indicating whether the configured at least one CG configuration is activated or deactivated (hereinafter “(de)activated) by the (de)activation command, according to a first indication of the RRC message, wherein the first indication is associated with the configured at least one CG configuration. In action 108, the UE transmits the CG confirmation MAC CE, to the BS, so that the BS knows that the UE has received the (de)activation command (e.g., configured grant Type 2 activation/deactivation).

The method 100 provides a CG confirmation reporting mechanism by which the UE determines a format of the CG confirmation MAC CE according to the RRC message that is used for configuring the CG configuration(s) of the UE. The RRC message may include a “configuredGrantConfig” parameter or a “configuredGrantConfigList” parameter as the abovementioned first indication for CG configuration(s). With “configuredGrantConfig”, one CG configuration is configured for the BWP of the cell, whereas with “configuredGrantConfigList”, multiple CG configurations are configured for the BWP of the cell. Thus, if the UE has been configured by “configuredGrantConfig” and has triggered CG confirmation (e.g., by the (de)activation command), the UE may, upon being allocated with an UL resource for a new transmission, report the NR Rel-15 CG confirmation MAC CE (e.g., a MAC CE without a payload) to the BS. On the other hand, if the UE has been configured with “configuredGrantConfigList” and has triggered CG confirmation (e.g., by the (de)activation command), the UE may, upon being allocated with a UL resource for a new transmission, report the NR Rel-16 CG confirmation MAC CE (e.g., a MAC CE with payload) to the BS.

Upon reception of an activation/deactivation command, the UE may trigger a CG confirmation. It is noted that the UE determines the received activation/deactivation command as the NR Rel-15 activation/deactivation command if the UE is configured with only one CG configuration in the BWP of the cell (e.g., “configuredGrantConfig” existing in the RRC message). On the contrary, the UE determines the received activation/deactivation command as the NR Rel-16 activation/deactivation command if the UE is configured with multiple CG configurations in the BWP of the cell (e.g., “configuredGrantConfigList” existing in the RRC message). Furthermore, there are two types of the NR Rel-16 activation/deactivation command Both types of activation/deactivation command may be indicated by the BS on a PDCCH scrambled with a Configured Scheduling (CS) Radio Network Temporary Identity (RNTI). One type of the NR Rel-16 activation/deactivation command may be a separate configured grant Type 2 activation/deactivation. The separate configured grant Type 2 activation/deactivation may activate/deactivate only one configured grant Type 2 configuration for the BWP of the cell according to a single piece of downlink control information (DCI). For example, a first separate configured grant Type 2 activation/deactivation is used for activating/deactivating a first configured grant Type 2 configuration for the BWP of the cell, and a second separate configured grant Type 2 activation/deactivation is used for activating/deactivating a second configured grant Type 2 configuration for the BWP of the cell. Another type of the NR Rel-16 activation/deactivation command may be a joint configured grant Type 2 activation/deactivation. The joint configured grant Type 2 activation/deactivation may activate/deactivate more than one configured grant Type 2 configuration for the BWP of the cell according to a single piece of DCI. Moreover, the values indicated in the redundancy version field of the DCI field of a joint configured grant Type 2 activation/deactivation may be set to all ‘0’s. In contrast, the values indicated in the HARQ process number field of the DCI field of a joint configured grant Type 2 activation/deactivation may or may not be set to all ‘0’s.

The values indicated in the redundancy version field of the DCI field of a separate configured grant Type 2 activation/deactivation may be set to all ‘0’s. In addition, the values indicated in the HARQ process number field of the DCI field of a separate configured grant Type 2 activation/deactivation may or may not be set to all ‘0’s.

The values indicated in the redundancy version field of the DCI field of a NR Rel-15 activation/deactivation command may be set to all ‘0’s. In addition, the values indicated in the HARQ process number field of the DCI field of a NR Rel-15 activation/deactivation command may also be set to all ‘0’s.

In some implementations, the UE determines the received activation/deactivation command as the NR Rel-15 activation/deactivation command if the UE is configured with only one CG configuration in the BWP of the cell and the received activation/deactivation command includes an indication (e.g., a DCI field) assigned to a fixed value. For example, the value indicated in the received activation/deactivation command may be ‘0’ or ‘1’ to (de)activate the one CG configuration. On the contrary, the UE determines the received activation/deactivation command as the NR Rel-16 activation/deactivation command if the UE is configured with multiple CG configurations in the BWP of the cell and the received activation/deactivation command includes an indication (e.g., a DCI field) assigned to a dynamic value. It is noted that the following Table 1 may be configured in “configuredGrantConfigList”, as the abovementioned first indication of the RRC message. In addition, the indication of the received activation/deactivation command is assigned to a dynamic value for (de)activating at least one configured CG configuration in the BWP of the cell. For example, the value indicated in the received activation/deactivation command may have a range from 0000 to 1111 (e.g., 16 indices). Each index may directly correspond to an index from Table 1, and the CG configuration(s) that maps to the index in Table 1 may be (de)activated. For example, index “0000” indicates the CG configurations with CG ID of ‘1’, ‘2’, and ‘3’ are (de)activated. Index “0001” indicates the CG configuration with CG ID of ‘1’ is (de)activated. Index “0010” indicates the CG configuration with CG ID of ‘5’ and ‘6’ are (de)activated.

TABLE 1

| Index | CG ID to be (de)activated |
|---|---|
| 0000 | 1, 2, 3 |
| 0001 | 1 |
| 0010 | 5, 6 |

In some implementation, the UE determines the received activation/deactivation command as the NR Rel-15 activation/deactivation command if the received activation/deactivation command includes the indication assigned to the fixed value. For example, the value indicated in the received activation/deactivation command may be ‘0’ or ‘1’ to be (de)activated only one CG configuration. On the contrary, the UE determines the received activation/deactivation command as the NR Rel-16 activation/deactivation command if the received activation/deactivation command includes the indication assigned to the dynamic value to be (de)activated one or more CG configuration(s). For example, the value indicated in the received activation/deactivation command may have the range from 0000 to 1111 (e.g., 16 indices). Each index may directly correspond to the index from the table 1, and the CG configuration(s) that maps to the index in the table may be (de)activated. For example, index “0000” indicates the CG configurations with CG ID of ‘1’, ‘2’, and ‘3’ are (de)activated.

When the CG confirmation has been triggered and not canceled, the UE may, upon reception of a UL grant, instruct the Multiplexing and Assembly procedure to generate a new CG confirmation MAC CE. Two cases of the new CG confirmation MAC CE (or called NR Rel-16 CG confirmation MAC CE) are disclosed.

Case 1: The Payload of the NR Rel-16 CG Confirmation MAC CE May have a Fixed Size

The NR Rel-16 CG confirmation MAC CE may be indicated by a MAC sub-header for a fixed-size MAC CE (e.g., with two header fields R/LCID), and the MAC CE may also in a fixed size (e.g., 8 bits/16 bits). The content (e.g., payload) of the MAC CE may indicate the activation/deactivation status of each CG configuration (e.g., configured grant Type 2 configuration) in terms of CG identity (ID).

In one implementation, the content (e.g., payload) of the MAC CE may indicate an ID of a serving cell and the activation/deactivation status of each CG configuration of this serving cell. In some implementations, the content (e.g., payload) of the MAC CE may indicate the ID of a serving cell and the activation/deactivation status of each configured grant Type 2 configuration of this serving cell. In one implementation, the content (e.g., payload) of the MAC CE may indicate an ID of a cell group and/or the activation/deactivation status of each CG configuration of this cell group. In some implementations, the content (e.g., payload) of the MAC CE may indicate the ID of a cell group and/or the activation/deactivation status of each CG Type 2 configuration of this cell group. In some implementations, the content (e.g., payload) of the MAC CE may indicate the ID of a BWP and the activation/deactivation status of each CG configuration of this BWP. In some implementations, the content (e.g., payload) of the MAC CE may indicate the ID of the BWP and the activation/deactivation status of each configured grant Type 2 configuration of this BWP.

It is noted that the ID of the BWP/serving cell/cell group is configured by the BS via a DL RRC message. The CG ID of a CG configuration in a BWP, serving cell, or cell group for indicating the activation/deactivation status of the CG configuration in the BWP, serving cell, or cell group may also be configured by the BS via a DL RRC message. In some implementations, the content (e.g., payload) of the MAC CE may indicate the ID of the BWP and the activation/deactivation status of each specific resource type of CG configuration of this BWP, wherein the specific resource type may not be a configured grant type 1 where an UL grant is provided by an RRC message, and stored as a configured UL grant, or a configured grant type 2 where an UL grant is provided by a PDCCH, and stored or cleared as a configured UL grant based on L1 signaling indicating configured UL grant activation or deactivation. The abovementioned CG configuration ID of each CG configuration may be configured by the BS, via a DL RRC message, before reception of the NR Rel-16 activation/deactivation command.

More specifically, the values of the bits (e.g., payload) of the NR Rel-16 CG confirmation MAC CE may be set to indicate the activation/deactivation status of each CG configuration based on the rules listed below:

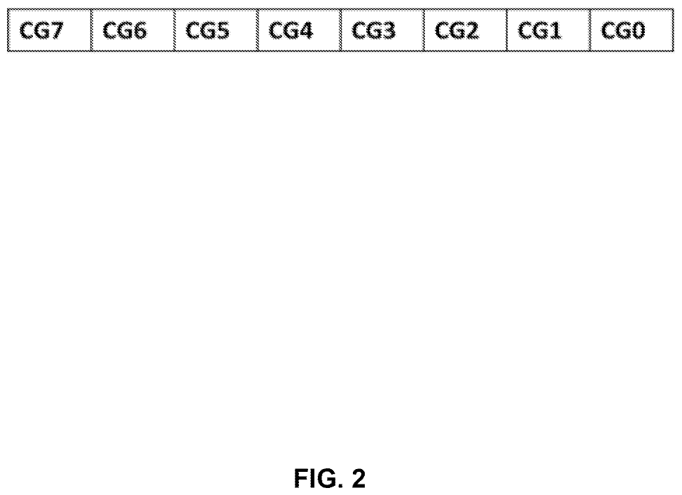

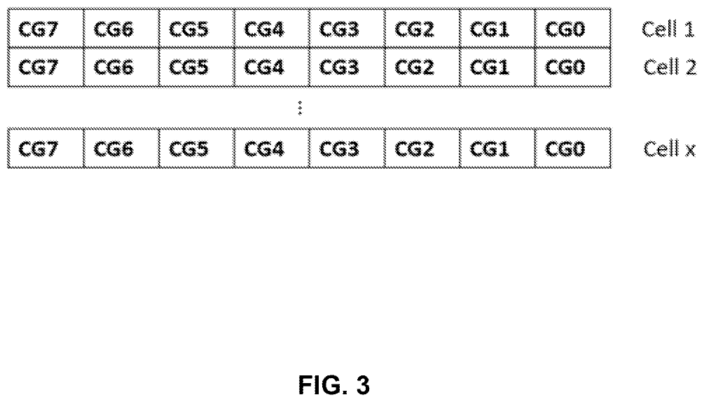

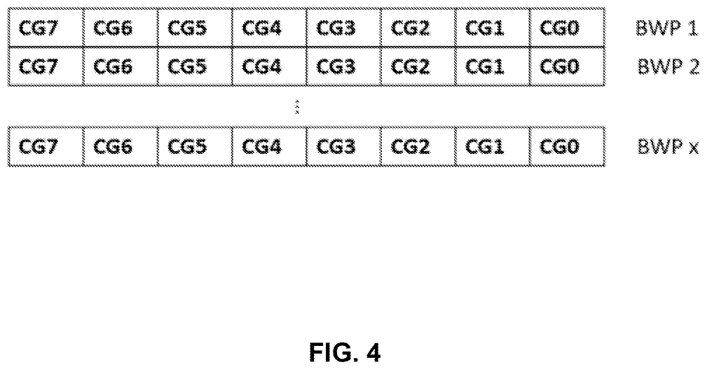

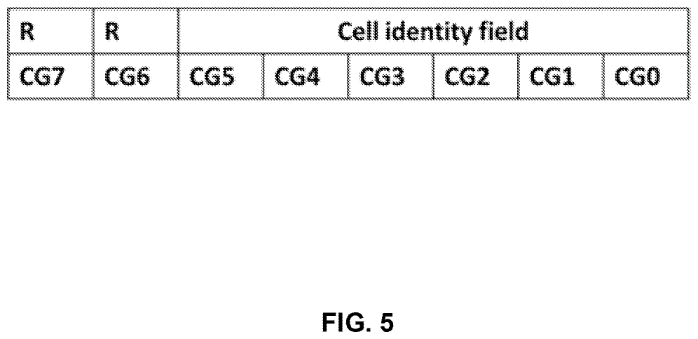

Rule 1: each bit of the MAC CE may be used for indicating the activation/deactivation status of a CG configuration. As shown in FIG. 2, the UE may be configured with eight CG configurations in a BWP of a serving cell, where each CG configuration corresponds to a CG configuration ID, which is represented as a CG(i) bit (e.g., CG0-CG7) of the MAC CE. The CG(i) bit set to “1” may be used to indicate that the CG (Type 2) configuration with the corresponding CG configuration ID is activated at a certain point in time (e.g., at the point in time the MAC CE is generated, or at the point in time the CG confirmation is triggered, etc.), whereas the CG(i) bit set to “0” may be used to indicate that the CG (Type 2) configuration with the corresponding CG configuration ID is deactivated at a certain point in time (e.g., the time the MAC CE is generated, or the time the CG confirmation is triggered, etc.). Alternatively, the CG(i) bit set to “0” may be used to indicate that the CG (Type 2) configuration with the corresponding CG configuration ID is activated at a certain point in time (e.g., at the time the MAC CE is generated, or at the time the CG confirmation is triggered, etc.), whereas the CG(i) bit set to “1” may be used to indicate that the CG (Type 2) configuration with the corresponding CG configuration ID is deactivated at a certain point in time (e.g., at the time the MAC CE is generated, or at the time the CG confirmation is triggered, etc.).

According to rule 1, the UE may simultaneously indicate the activation/deactivation status of the CG configurations of multiple cells/BWPs, where the MAC CE may include replicated CG(i) bits. With reference to FIG. 3, each row may represent the activation/deactivation status of the CG (Type 2) configurations (e.g., CG0-CG7) of a specific serving cell (e.g., Cell 1-Cell x) with reference to FIG. 4, each row may represent the activation/deactivation status of the CG (Type 2) configurations (e.g., CG0-CG7) of a specific BWP (e.g., BWP 1-BWP x). In addition, the MAC CE may include the cell identity field, two reserved bits (denoted by R), and CG(i) bits (e.g., CG0-CG7), as shown in FIG. 5. In FIG. 5, the CG(i) bits indicate the activation/deactivation status of the CG configurations of a specific serving cell, which is indicated by the six-bit cell identity field (e.g., “000000” may indicate the serving cell #1, “000001” may indicate the serving cell #2, etc.).

With this MAC CE format, the UE can indicate the activation/deactivation status of the CG (Type 2) configurations on a specific serving cell. In one implementation, the MAC CE may include the cell identity field, two-bit BWP ID field, and CG(i) bits, as shown in FIG. 6. In FIG. 6, the CG(i) bits indicate the activation/deactivation status of the CG (Type 2) configurations of a specific BWP, and the identity of the BWP is indicated by the two-bit BWP ID field (e.g., “00” represents BWP #1, “01” represents BWP #2, etc.). Moreover, the indicated BWP is configured in a specific serving cell, and the identity of this serving cell is indicated by the six-bit cell identity field (e.g., “000000” indicates the serving cell #1, “000001” indicates the serving cell #2, etc.). With this MAC CE format, the UE can indicate the activation/deactivation status of the CG (Type 2) configurations of a specific BWP on a specific serving cell.

Rule 2: each bit, CG(i), may be used for indicating a specific CG (Type 2) configuration, as shown in FIG. 2. The CG(i) bit set to “1” may indicate that the NR Rel-16 activation/deactivation command (e.g., configured grant Type 2 activation/deactivation) for the CG (Type 2) configuration with the corresponding CG configuration ID has been received (within a predefined time, e.g., in the slot/subframe where the CG confirmation has been triggered, before the generation of the MAC PDU). The CG(i) bit set to “0” may indicate that the NR Rel-16 activation/deactivation command for the CG (Type 2) configuration with the corresponding CG configuration ID has not been received (within a predefined time, e.g., in the slot/subframe where the CG confirmation has been triggered).

It is noted that one or more NR Rel-16 activation/deactivation commands may be received before the UE generates the MAC CE. In one implementation, the CG configuration ID may be BWP-specific, cell-specific, or cell group-specific. In one implementation, a single MAC CE may indicate the activation/deactivation status of one or more CG (Type 2) configurations due to the reception of one or more NR Rel-16 activation/deactivation commands.

According to rule 2, the UE may simultaneously indicate the activation/deactivation status of the CG (Type 2) configurations of multiple cells/BWPs, where the MAC CE may include replicated CG(i) bits. With reference to FIG. 3, each row may represent the activation/deactivation status of the CG (Type 2) configurations (e.g., CG0-CG7) of a specific serving cell (e.g., Cell 1-Cell x). In FIG. 4, each row may represent the activation/deactivation status of the CG (Type 2) configurations (e.g., CG0-CG7) of a specific BWP (e.g., BWP 1-BWP x).

In addition, the MAC CE may include the cell identity field, two reserved bits (denoted by R), and CG(i) bits (e.g., CG0-CG7), as shown in FIG. 5. In FIG. 5, the CG(i) bits indicate the activation/deactivation status of the CG (Type 2) configurations of a specific serving cell, which is indicated by the six-bit cell identity field (e.g., “000000” may indicate the serving cell Cell1, “000001” may indicate the serving cell Cell2, etc.).

With this MAC CE format, the UE can indicate the activation/deactivation status of the CG (Type 2) configurations on a specific serving cell. In one implementation, the MAC CE may include the cell identity field, two-bit BWP ID field, and CG(i) bits, as shown in FIG. 6. In FIG. 6, the CG(i) bits indicate the activation/deactivation status of the CG (Type 2) configurations of a specific BWP, and the identity of the BWP is indicated by the two-bit BWP ID field (e.g., “00” represents BWP #1, “01” represents BWP #2, etc.). The indicated BWP is configured in a specific serving cell, and the identity of this serving cell is indicated by the six-bit cell identity field (e.g., “000000” represents serving cell #1, “000001” represents serving cell #2, etc.). With this MAC CE format, the UE can indicate the activation/deactivation status of the CG (Type 2) configurations of a specific BWP on a specific serving cell.

The NR Rel-16 CG confirmation MAC CE explicitly indicates whether the NR Rel-16 activation/deactivation command for a CG (Type 2) configuration with a CG configuration ID has been received. Thus, the BS knows which CG (Type 2) configuration(s) of one or more CG (Type 2) configurations of at least one BWP on at least one serving cell are activated/deactivated via the received NR Rel-16 CG confirmation MAC CE (e.g., CG(i) bits).

Case 2: The Payload of the NR Rel-16 CG Confirmation MAC CE May have Different Sizes

The NR Rel-16 CG confirmation MAC CE may have two sizes. To be more specific, either a fixed size of X bits, e.g. 8 bits (one octet), or a fixed size of Y bits, e.g., 16 bits (two octets). The MAC CE with X bits and the MAC CE with Y bits may be indicated by different LCID values. The UE may select either the MAC CE with X bits or Y bits based on some conditions.

For example, the condition may be that if none of the CG configuration ID(s) (e.g., CG(i) bit) of the CG configuration(s) on a serving cell is larger than a certain value (e.g., 7), the CG confirmation MAC CE of X bits (e.g., 8 bits is applied. Otherwise, the CG confirmation MAC CE of Y bits (e.g., 16 bits) is applied.

In another example, the condition may be based on the configured number of CG configurations for a given BWP on a serving cell. If the UE is configured with a number of X or a number smaller than X of CG configurations of a given BWP on a serving cell or if the UE is configured with a number of X or a number smaller than X of CG configurations per serving cell/cell group, the CG confirmation MAC CE of X bits may be applied. Otherwise, if the UE is configured with more than a number X of CG configurations of a given BWP on a serving cell or if the UE is configured with more than a number of X CG configurations per serving cell/cell group, the CG confirmation MAC CE of Y bits (e.g., 16 bits) may be applied. In this case, the content (e.g., payload) of the MAC CE may indicate the ID of the BWP and the activation/deactivation status of each specific type of CG configuration (e.g., CG Type 1 configuration, CG Type 2 configuration, etc.) of this BWP. In another case, the content (e.g., payload) of the MAC CE may indicate the ID of a cell group and/or the activation/deactivation status of each specific type of CG configuration (e.g., CG Type 1 configuration, CG Type 2 configuration, etc.) of this cell group.

Moreover, the CG configuration ID of each CG configuration may be configured by the BS, via a DL RRC message, before reception of the NR Rel-16 activation/deactivation command. The value of each bit in the MAC CE may be set based on either one of the rules mentioned above. In addition, the MAC CE of X bits may be the NR Rel-15 CG confirmation MAC CE, whereas the MAC CE of Y bits may be the NR Rel-16 CG confirmation MAC CE.

When the conditions to generate a CG confirmation MAC CE are satisfied (e.g., when the MAC entity has UL resources allocated for a new transmission, while at least one CG confirmation has been triggered and not canceled), the UE may generate a MAC CE with a fixed size of zero bits if either one of the conditions listed below is satisfied. This MAC CE may or may not be indicated by the same LCID as the NR Rel-15 CG confirmation MAC CE.

Condition 1. all the CG configurations for a given BWP on a serving cell have been activated;

Condition 2. all the CG configurations for a given BWP on a serving cell have been deactivated;

Condition 3. only the specific/default CG configurations corresponding to a cell/BWP/cell-group have been activated/deactivated.

The UE may, upon reception of a UL grant, instruct the Multiplexing and Assembly procedure to generate a CG confirmation MAC CE without a payload if the CG confirmation has been triggered and not canceled

In one implementation, the MAC CE may be indicated by an identical LCID (e.g. LCID value of 55). The MAC CE may have a MAC CE format with a fixed size of zero bits.

It is noted that the MAC CE may be transmitted on a specific UL resource(s) to implicitly indicate that the UE has received the NR Rel-16 activation/deactivation command for a CG configuration to the network. For example, if a separate configured grant Type 2 activation/deactivation is received, the specific UL resource may be the physical UL shared channel (PUSCH) duration(s) of the configured grant Type 2 configuration configurations as indicated in the configured grant Type 2 activation/deactivation. On the other hand, if a joint configured grant Type 2 activation/deactivation is received, the specific UL resource may be a PUSCH duration of the configured grant Type 2 configuration, which has the largest/smallest CG configuration ID among all configured grant Type 2 configurations indicated by the configured grant Type 2 activation/deactivation.

In another example, if a joint configured grant Type 2 activation/deactivation is received, the specific UL resource can be, but is not limited to, being determined by the indication in the physical layer, where the indication can be, but is not limited to, being contained in a DCI of the joint configured grant Type 2 activation/deactivation. In other examples, if a joint configured grant Type 2 activation/deactivation is received, the specific UL resource may be a PUSCH duration of a specific configured grant Type 2 configuration.

In addition, the specific UL resource may be a PUSCH duration, which corresponds to a specific Hybrid Automatic Repeat Request (HARQ) ID. In this implementation, the CG configuration ID for each CG configuration may be provided by the BS via an RRC message before the reception of the NR Rel-16 activation/deactivation command Some restrictions may be introduced to restrict the transmission of the generated CG confirmation MAC CE on the specific UL resource(s). These restrictions are disclosed as follows:

Restriction 1. if a CG confirmation has been triggered and not canceled, the MAC entity may, upon a UL resource allocated for new transmission becomes available, further check whether the available UL resource corresponds to the abovementioned specific UL resource. The MAC entity may only instruct the Multiplexing and Assembly procedure to generate NR Rel-16 CG confirmation MAC CE when the UL resource is qualified as the abovementioned specific UL resource. Otherwise, the UE may not generate the NR Rel-16 CG confirmation MAC CE.

Restriction 2. if a CG confirmation has been triggered and not canceled, the MAC entity may, upon a UL resource allocated for new transmission becomes available, instruct the Multiplexing and Assembly procedure to generate NR Rel-16 CG confirmation MAC CE, and assign a specific logical channel prioritization (LCP) mapping restriction to the generated MAC CE. It is noted that either the RRC entity or MAC entity may provide the LCP restriction to the MAC CE. As such, while Multiplexing and Assembly entity generates the MAC PDU, the MAC entity may check the LCP restriction of the MAC CE and determine whether the MAC CE can be included in the MAC PDUs. Therefore, the generated MAC CE may only be mapped to the abovementioned specific UL resources.

Restriction 3. a CG confirmation may be triggered on a per CG configuration basis, specifically a configuration-based confirmation. The triggered configuration-based confirmation may be canceled when NR Rel-16 CG confirmation MAC CE is transmitted on a PUSCH duration of the CG configuration (e.g., the PUSCH duration that is stored and cleared as the CG configuration, which periodically occurs based on the periodicity of the CG configuration).

For example, if two CG configurations are configured by the BS, one with a CG configuration ID of 1 and the other with a CG configuration ID of 2. Then, if the UE receives a configured grant Type 2 activation/deactivation of these two configurations, two configuration-based confirmations may be triggered. One of the configuration-based confirmations corresponds to the CG configuration ID of 1 and another corresponds to the CG configuration ID of 2.

The triggered configuration-based confirmation which corresponds to the CG configuration ID of 1 may be canceled when a new MAC CE is transmitted on a PUSCH duration of the CG configuration ID of 1. Likewise, the triggered configuration-based confirmation which corresponds to the CG configuration ID of 2 may be canceled when NR Rel-16 CG confirmation MAC CE is transmitted on a PUSCH duration of the CG configuration ID of 2. The mechanism introduced in this case is to ensure the triggered configuration-based confirmation is not canceled until NR Rel-16 CG confirmation MAC CE is transmitted on the abovementioned specific UL resource.

In addition, various methods for the UE to determine whether to report the NR Rel-15 CG confirmation MAC CE or the NR Rel-16 CG confirmation MAC CE are disclosed.

In a first method, upon reception of a UL grant on the PDCCH for the CS-RNTI of the MAC entity for configured grant Type 2 activation/deactivation, the UE may further determine whether the DCI field indicates the NR Rel-16 activation/deactivation command. If so, the UE reports the NR Rel-16 CG confirmation MAC CE. On the other hand, if the DCI field indicates NR Rel-15 activation/deactivation command (e.g., the value indicated in both the HARQ process number field and redundancy version field of the DCI are set to all ‘0’s), the UE reports the NR Rel-15 CG confirmation MAC CE (e.g., report the NR Rel-15 CG confirmation MAC CE indicated by the LCID index of 55 on any available UL resource whenever a CG confirmation is triggered and not canceled).

In an example, the NR Rel-16 activation/deactivation command may be a separate configured grant Type 2 activation/deactivation. In another example, the NR Rel-16 activation/deactivation command may be a joint configured grant Type 2 activation/deactivation. The DCI field may be used to distinguish between the NR Rel-15 activation/deactivation command and the NR Rel-16 activation/deactivation command.

For example, a bit in the DCI field set to “1” may indicate the NR Rel-16 activation/deactivation command, and a bit in the DCI field set to “0” may indicate the NR Rel-15 activation/deactivation command. Alternatively, a bit in the DCI field set to “0” may indicate NR Rel-16 activation/deactivation command, and a bit in the DCI field set to “1” may indicate the NR Rel-15 activation/deactivation command.

In a second method, when a condition of generating a CG confirmation MAC CE is satisfied in the MAC entity (i.e., the CG confirmation has been triggered and not canceled, and the MAC entity is provided with UL resource for a new transmission), the UE may further check whether any of the CG confirmation is triggered by the NR Rel-16 activation/deactivation command. If so, the UE report the NR Rel-16 CG confirmation MAC CE. On the other hand, if all the CG confirmations are triggered by the NR Rel-15 activation/deactivation command (e.g., the DCI field indicates the NR Rel-15 activation/deactivation command), the UE reports the NR Rel-15 CG confirmation MAC CE indicated by the LCID index of 55 on any available UL resource whenever a CG confirmation is triggered and not cancelled.

In an example, the NR Rel-16 activation/deactivation command may be a separate configured grant Type 2 activation/deactivation. In another example, the NR Rel-16 activation/deactivation command may be a joint configured grant Type 2 activation/deactivation. The specific DCI field may be used to distinguish between the NR Rel-15 activation/deactivation command and the NR Rel-16 activation/deactivation command. For example, a bit in the DCI field set to “1” may indicate the NR Rel-16 activation/deactivation command, and a bit in the DCI field set to “0” may indicate the NR Rel-15 activation/deactivation command. Alternatively, a bit in the DCI field set to “0” may indicate the NR Rel-16 activation/deactivation command, and a bit in the DCI field set to “1” may indicate the NR Rel-15 activation/deactivation command.

In a third method, the UE may, upon reception of a UL grant for configured grant Type 2 activation/deactivation, determine whether the activated/deactivated CG configuration is the only CG configuration for a given BWP of a serving cell (e.g., if “configuredGrantConfig” is configured for the given BWP of the serving cell). If so, the UE may report the NR Rel-15 CG confirmation MAC CE indicated by the LCID index of 55 on any available UL resource whenever a CG confirmation is triggered and not canceled). Otherwise, the UE may report the NR Rel-16 CG confirmation MAC CE. The configured grant Type 2 activation/deactivation may be the NR Rel-15 activation/deactivation command (e.g., the DCI content indicates the NR Rel-15 activation/deactivation command).

On the other hand, the configured grant Type 2 activation/deactivation may be the NR Rel-16 activation/deactivation command, e.g., either a joint configured grant Type 2 activation/deactivation or a separate configured grant Type 2 activation/deactivation. The specific DCI field may be used to distinguish between the NR Rel-15 activation/deactivation command and the NR Rel-16 activation/deactivation command.

In one example, a bit in the DCI field set to “1” may indicate the NR Rel-16 activation/deactivation command, and a bit in the DCI field set to “0” may indicate the NR Rel-15 activation/deactivation command. Alternatively, a bit in the DCI field set to “0” may indicate the NR Rel-16 activation/deactivation command, and a bit in the DCI field set to “1” may indicate the NR Rel-15 activation/deactivation command. Alternatively, the UE determines the received activation/deactivation command as a NR Rel-16 activation/deactivation command if it is configured with more than one CG configuration in the BWP of the cell.

On the other hand, the UE considers the received activation/deactivation command as the NR Rel-15 activation/deactivation command if it is configured with only one CG configuration in the BWP of the cell. In some implementations, if the UE receives a separate configured grant Type 2 activation/deactivation, the UE generates and reports one MAC CE in a MAC PDU as legacy (e.g., the NR Rel-15 CG confirmation MAC CE). On the other hand, if the UE receives a joint configured grant Type 2 activation/deactivation, the UE generates and reports “two” NR Rel-15 CG confirmation MAC CEs in a MAC PDU.

Upon generating the CG confirmation MAC CE (e.g., the NR Rel-15 CG confirmation MAC CE or the NR Rel-16 CG confirmation MAC CE), the ongoing LCP procedure may be interrupted due to intra-UE UL prioritization. Hence, the triggered CG confirmation may be canceled when a MAC PDU, which includes the CG confirmation MAC CE, has been delivered to the identified HARQ process.

In one implementation, the confirmation MAC CE may have higher LCP priority than a MAC CE for a buffer status report (BSR) excluding a BSR included for padding, PHR MAC CE, data from any logical channel except data from UL Common Control Channel (CCCH), recommended bit rate query, a BSR included for padding In some implementations, the CG confirmation MAC CE may have lower LCP priority than Cell Radio Network Temporary Identifier (C-RNTI) MAC CE or data from a UL-CCCH.

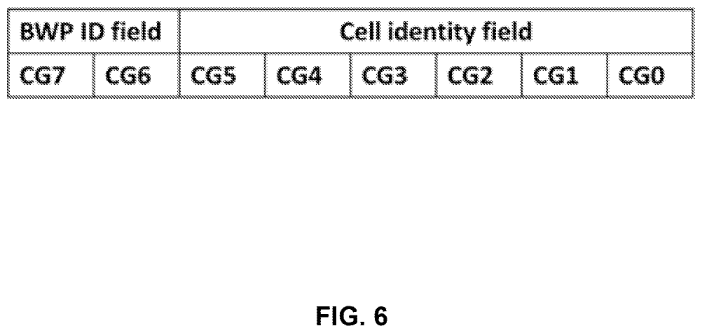

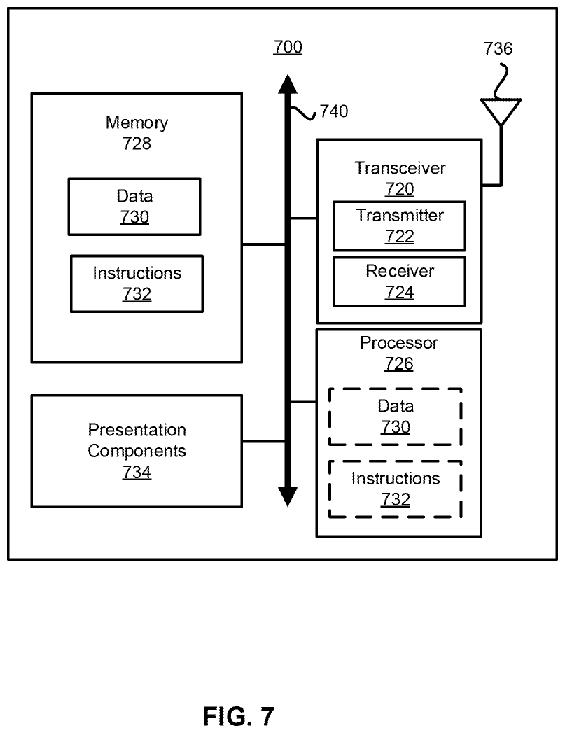

FIG. 7 illustrates a node 700 for wireless communication according to the present disclosure.

As illustrated in FIG. 7, the node 700 may include a transceiver 720, a processor 726, memory 728, one or more presentation components 734, and at least one antenna 736. The node 700 may also include a Radio Frequency (RF) spectrum band module, a BS communications module, a network communications module, and a system communications management module, input/output (I/O) ports, I/O components, and a power supply (not shown). Each of these components may be in communication with each other, directly or indirectly, over one or more buses 740. The node 700 may be a UE that performs various disclosed functions as illustrated in FIG. 1.

The transceiver 720 includes a transmitter 722 (with transmitting circuitry) and a receiver 724 (with receiving circuitry) and may be configured to transmit and/or receive time and/or frequency resource partitioning information. The transceiver 720 may be configured to transmit in different types of subframes and slots including, but not limited to, usable, non-usable and flexibly usable subframes and slot formats. The transceiver 720 may be configured to receive data and control channels.

The node 700 may include a variety of computer-readable media. Computer-readable media may be any media that can be accessed by the node 700 and include both volatile and non-volatile media, removable and non-removable media. Computer-readable media may include computer storage media and communication media. Computer storage media includes both volatile and non-volatile, as well as removable and non-removable media implemented in any method or technology for storage of information such as computer-readable instructions, data structures, program modules or other data.

Computer storage media includes RAM, ROM, EEPROM, flash memory or other memory technology, Compact Disc Read-Only Memory (CD-ROM), digital versatile disks (DVD) or other optical disk storage, magnetic cassettes, magnetic tape, magnetic disk storage or other magnetic storage devices. Computer storage media does not include a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media includes wired media such as a wired network or direct-wired connection, and wireless media such as acoustic, radio frequency (RF), infrared and other wireless media. Combinations of any of the disclosed media should be included within the scope of computer-readable media.

The memory 728 may include computer-storage media in the form of volatile and/or non-volatile memory. The memory 728 may be removable, non-removable, or a combination thereof. Memory includes solid-state memory, hard drives, and optical-disc drives. As illustrated in FIG. 7, the memory 728 may store computer-readable, computer-executable instructions 732 (e.g., software codes) that are configured to cause the processor 726 (e.g., processing circuitry) to perform various disclosed functions. Alternatively, the instructions 732 may be configured to cause the node 700 (e.g., when compiled and executed) to perform various disclosed functions.

The processor 726 may include an intelligent hardware device (e.g., a central processing unit (CPU), a microcontroller, an Application Specific Integrated Circuit (ASIC), etc.). The processor 726 may include memory. The processor 726 may process the data 730 and the instructions 732 received from the memory 728, and information received via the transceiver 720, the baseband communications module, and/or the network communications module. The processor 726 may also process information to be sent to the transceiver 720 for transmission via the antenna 736, to the network communications module for transmission to a CN.

One or more presentation components 734 present data to a person or other device. Presentation components 734 include a display device, speaker, printing component, and vibrating component.

From the present disclosure, it is evident that various techniques can be utilized for implementing the concepts of the present disclosure without departing from the scope of those concepts. Moreover, while the concepts have been described with specific reference to certain implementations, a person of ordinary skill in the art would recognize that changes can be made in form and detail without departing from the scope of those concepts. As such, the disclosure is to be considered in all respects as illustrative and not restrictive. It should also be understood that the present disclosure is not limited to the particular described implementations, but that many rearrangements, modifications, and substitutions are possible without departing from the scope of the present disclosure.

1. A method of reporting a configured grant (CG) confirmation for a user equipment (UE) of a wireless communication system, the method comprising:
receiving, from a network of the wireless communication system, radio resource control (RRC) message for configuring the UE with at least one CG configuration in a bandwidth part (BWP) of a cell;
receiving, from the network, a (de)activation command for activating or deactivating the configured at least one CG configuration;
generating a medium access control (MAC) control element (CE) for reporting the CG confirmation indicating whether the configured at least one CG configuration is activated or deactivated by the (de)activation command, according to a first indication of the RRC message, the first indication being associated with the configured at least one CG configuration; and
transmitting the MAC CE; to the network.

2. The method of claim 1, wherein the first indication of the RRC message is further associated with a number of a plurality of CG configurations in the BWP of the cell.

3. The method of claim 2, wherein the first indication of the RRC message is used for configuring the plurality of CG configurations in the BWP of the cell.

4. The method of claim 1, wherein the MAC CE includes only a subheader or both a subheader and a payload for the at least one CG confirmation according to the first indication of the RRC message.

5. The method of claim 4, wherein the payload of the MAC CE includes a plurality of CG identifier (ID) fields, and each of the plurality of CG ID fields corresponds to one of plurality of CG configurations.

6. The method of claim 5, wherein each of the plurality of CG ID fields is set to a first value for indicating that the (de)activation command has been received for the corresponding one of the plurality of CG configurations, and set to a second value for indicating that the (de)activation command has not been received for the corresponding one of the plurality of CG configurations.

7. The method of claim 1, wherein the (de)activation command includes a second indication for indicating that one or more of the at least one CG configuration is activated or deactivated.

8. The method of claim 7, wherein the second indication is associated with a CG configuration identifier.

9. The method of claim 7, wherein the (de)activation command is received via downlink control information (DCI), and a type of the (de)activation command is determined by the UE according to at least one of the first indication of the RRC message and the second indication of the (de)activation command.

10. A user equipment (UE) for reporting a configured grant (CG) confirmation, the UE comprising:
a processor, for executing computer-executable instructions; and
a non-transitory machine-readable medium, coupled to the processor, for storing the computer-executable instructions, wherein the computer-executable instructions instruct the processor to:
receive, from a network of the wireless communication system, a radio resource control (RRC) message for configuring the UE with at least one CG configuration in a bandwidth part (BWP) of a cell;
receive, from the network, a (de)activation command for activating or deactivating the configured at least one CG configuration;
generate a medium access control (MAC) control element (CE) for reporting the CG confirmation indicating whether the configured at least one CG configuration is activated or deactivated by the (de)activation command, according to a first indication of the RRC message, the first indication being associated with the configured at least one CG configuration; and
transmit the MAC CE to the network.

11. The UE of claim 10, wherein the first indication of the RRC message is further associated with a number of a plurality of CG configurations in the BWP of the cell.

12. The UE of claim 11, wherein the first indication of the RRC message is used for configuring the plurality of CG configurations in the BWP of the cell.

13. The UE of claim 10, wherein the MAC CE includes only a subheader or both a subheader and a payload for the at least one CG confirmation according to the first indication of the RRC message.

14. The UE of claim 13, wherein the payload of the MAC CE includes a plurality of CG identifier (ID) fields, and each of the plurality of CG ID fields corresponds to one of a plurality of CG configurations.

15. The UE of claim 14, wherein each of the plurality of CG ID fields is set to a first value for indicating that the (de)activation command has been received for the corresponding one of the plurality of CG configurations, and set to a second value for indicating that the (de)activation command has not been received for the corresponding one of the plurality of CG configurations.

16. The UE of claim 10, wherein the (de)activation command includes a second indication for indicating that one or more of the at least one CG configuration is activated or deactivated.

17. The UE of claim 16, wherein the second indication is associated with a CG configuration identifier.

18. The UE of claim 16, wherein the (de)activation command is received via downlink control information (DCI), and a type of the (de)activation command is determined by the UE according to at least one of the first indication of the RRC message and the second indication of the (de)activation command.
